(19) United States
(12) Patent Application Publication
(10) Pub. No.: US 2008/0005335 A1
(43) Pub. Date: Jan. 3, 2008

(54) Method and system for network establishment of peripheral

(75) Inventor: Tae-jung Yun, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/638,469

(22) Filed: Dec. 14, 2006

(30) Foreign Application Priority Data
May 24, 2006 (KR) 10-2006-0046542

(51) Int. Cl. G06F 15/16

(52) U.S. Cl. 709/227

(57) ABSTRACT

A method and system for network establishment of a peripheral are provided, wherein the method includes setting a predetermined area of a memory of the peripheral as an area for a mass storage class (MSC) so that the peripheral can be recognized by a host as supporting the MSC, storing establishment data for networking the host and the peripheral in the predetermined area of the peripheral recognized as supporting the MSC, and performing network establishment of the peripheral using the stored establishment data.

### CROSS-REFERENCE TO RELATED PATENT APPLICATION

This application claims the benefit under 35 U.S.C. §119(a) of Korean Patent Application No. 10-2006-0046542, filed in the Korean Intellectual Property Office on May 24, 2006, the entire disclosure of which is incorporated herein by reference.

### BACKGROUND OF THE INVENTION

1. Field of the Invention

The present invention relates to network establishment of a peripheral to a host. More particularly, the present invention relates to a method and system for easily performing network establishment of a peripheral without using a portable storage medium.

2. Description of the Related Art

One of the main obstacles to non-specialist users when setting up network devices in home and non-industrial environments is that they must be able to understand a wide range of different wireless network technologies. The setting up of network devices often requires detailed knowledge about hardware, software, and network protocols, and such knowledge can be too complex for general users. In addition, peripherals such as a thin-client device having an embedded operating system and a simple user interface have become available on the market. However, it is difficult to set up a network client apparatus using peripherals such as a thin-client device due to lack of convenient and intuitive interfaces.

In order to facilitate the setting up of network devices, network establishment can be performed by storing establishment data in a portable storage medium and transferring the stored establishment data to a thin-client device. However, to establish a network of thin-client devices using a portable storage medium, a host must include a memory card slot, and a user must perform network establishment in each of the thin-client devices after inserting the portable storage medium in which establishment data of the host is stored into each of the thin-client devices. Further, the thin-client devices must include a universal serial bus (USB) host or an interface with the portable storage medium. This increases the manufacturing costs of thin-client devices.

Accordingly, a need exists for an improved system and method of performing network establishment of peripherals.

### SUMMARY OF THE INVENTION

Embodiments of the present invention are provided to substantially solve the above and other problems, and provide a network establishment method and system of a peripheral to easily perform network establishment of host peripherals such as thin-client devices without using a portable storage medium.

According to an aspect of embodiments of the present invention, a method for network establishment of a peripheral is provided, the method comprising setting a predetermined area of a memory of the peripheral as an area for a mass storage class (MSC) so that the peripheral can be recognized by a host as supporting a MSC, and storing establishment data for networking the host and the peripheral in the predetermined area of the peripheral recognized as supporting the MSC and performing network establishment of the peripheral using the stored establishment data.

According to another aspect of embodiments of the present invention, a system for network establishment of a peripheral is provided, the system comprising at least one peripheral, the peripheral comprising a memory in which a predetermined area of the memory is set as an area for a mass storage class (MSC) so that the peripheral can be recognized as supporting the MSC. The system further comprises establishment data for the network stored in the predetermined area of the peripheral recognized as supporting the MSC, such that the system can perform network establishment using the stored establishment data. The system further comprises a host for recognizing the peripheral as having a peripheral class and supporting the MSC when the peripheral is connected to the host, and for transmitting the establishment data to the peripheral.

### BRIEF DESCRIPTION OF THE DRAWINGS

The above and other features and advantages of embodiments of the present invention will become more apparent by describing in detail exemplary embodiments thereof with reference to the attached drawings, in which:

FIG. 1 is a flowchart illustrating a method for network establishment of a peripheral according to an exemplary embodiment of the present invention;

FIG. 2 is a flowchart illustrating an operation of FIG. 1, in which network establishment of the peripheral is performed using establishment data stored in a predetermined area, according to an exemplary embodiment of the present invention;

FIG. 3 is a flowchart illustrating an operation of FIG. 2, in which establishment data is stored in the predetermined area of the peripheral, according to an exemplary embodiment of the present invention;

FIG. 4 illustrates a dialog box used to designate a predetermined memory of a peripheral in which to store input establishment data, according to an exemplary embodiment of the present invention;

FIG. 5 illustrates establishment data according to an exemplary embodiment of the present invention;

FIG. 6 is a flowchart illustrating a process of detecting a network establishment result of FIG. 2, according to an exemplary embodiment of the present invention;

FIG. 7 is a signaling diagram for explaining a process of establishing a network between a personal computer (PC) and a printer according to an exemplary embodiment of the present invention; and

FIG. 8 is a block diagram of a network establishment system of a peripheral according to an exemplary embodiment of the present invention.

Throughout the drawings, like reference numerals will be understood to refer to like parts, components and structures.

### DETAILED DESCRIPTION OF EXEMPLARY EMBODIMENTS

The present invention will now be described more fully with reference to the accompanying drawings, in which exemplary embodiments of the invention are shown.

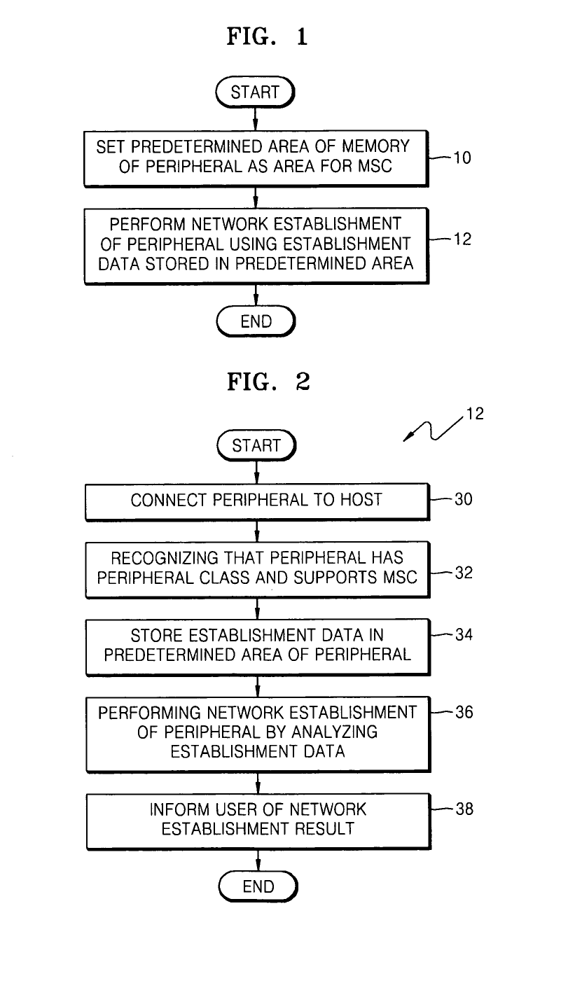

FIG. 1 is a flowchart illustrating a method for network establishment of a peripheral according to an embodiment of the present invention.

Referring to FIG. 1, in order for a peripheral to be recognized by a host as supporting a mass storage class (MSC), a predetermined area of the peripheral is set as an area for the MSC in operation 10. MSC denotes a device classification standard for the host to recognize peripherals as external storage media. Herein, the peripherals include image forming devices such as printers, scanners, photocopiers, and multi-function peripherals (MFPs), but are not limited thereto. A predetermined area of a specific memory among a data storage area of the peripheral is set as storage space, and the predetermined area can be used as an external storage medium.

Here, the memory is a volatile memory (e.g., a random access memory (RAM)) or nonvolatile memory (e.g., a flash memory), but is not limited thereto.

In operation 12, establishment data for networking the host and the peripheral is stored in the predetermined area of the peripheral supporting the MSC, and network establishment of the peripheral is performed using the stored establishment data. Here, the establishment data denotes data that is used to establish a network between the host and the peripheral and includes device setup information, security information, file sharing information, and so forth.

FIG. 2 is a flowchart illustrating operation 12 of FIG. 1 in greater detail, according to an exemplary embodiment of the present invention.

Referring to FIG. 2, the peripheral is connected to the host in operation 30. Here, the peripheral can be connected to the host in a wired or wireless manner. When the peripheral is connected to the host in a wired manner, a USB device or the like can be used, and when the peripheral is connected to the host in a wireless manner, a wireless USB (WUSB), Bluetooth device or the like can be used.

In operation 32, the host recognizes that the peripheral supports a peripheral class and supports the MSC. “Peripheral class” is a device classification standard used by the host to recognize peripherals. For example, if the peripheral is a printer, “peripheral class” denotes a classification standard which is used by the host to recognize the printer as having a printer class. The host recognizes the peripheral as supporting a “peripheral class”, which is the peripheral's own classification standard, and also as supporting the MSC due to the predetermined area of the peripheral set as an area for the MSC in operation 10.

In operation 34, establishment data for establishing a network between the host and the peripheral is stored in the predetermined area of the peripheral.

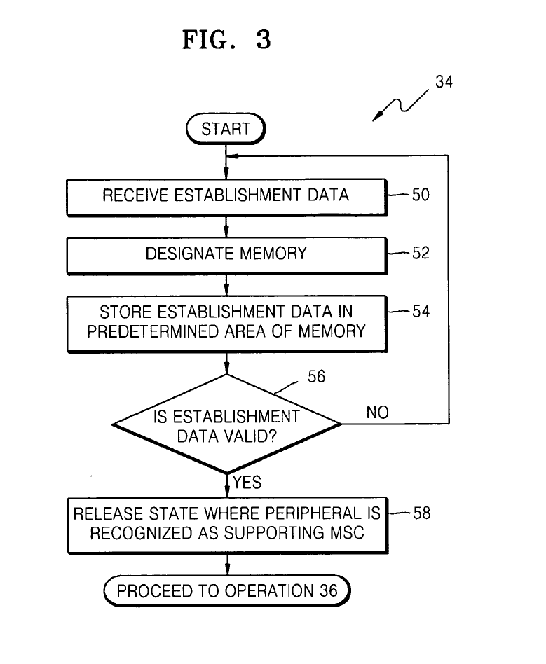

FIG. 3 is a flowchart illustrating operation 34 of FIG. 2 in greater detail, according to an exemplary embodiment of the present invention.

Referring to FIG. 3, establishment data is input to the host in operation 50. The establishment data is input for example, through an application of the host.

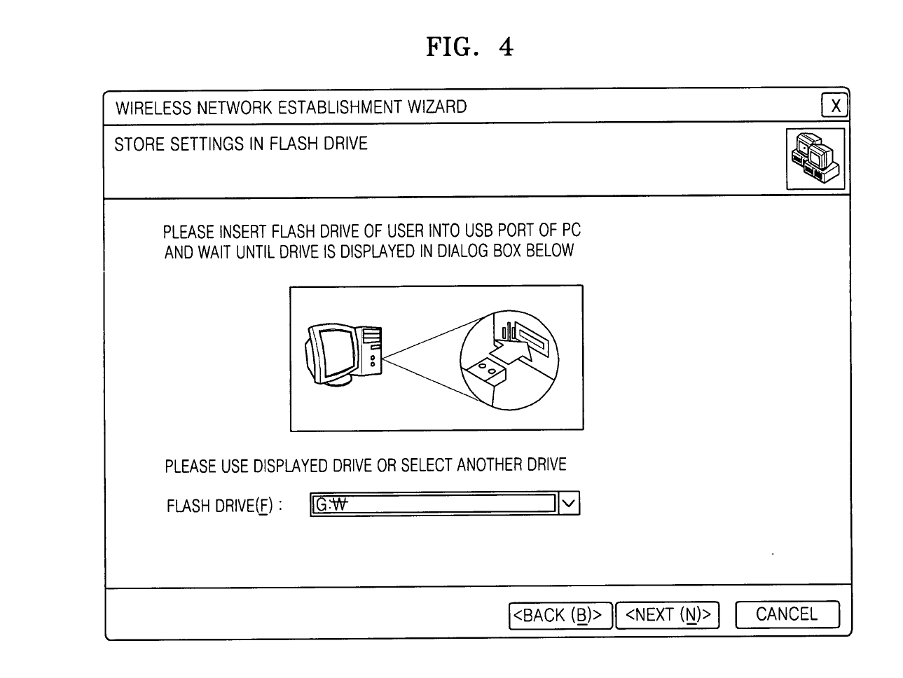

In operation 52, a memory of the peripheral is designated in which to store the input establishment data. FIG. 4 illustrates a dialog box used to designate a predetermined memory of the peripheral in which to store the input establishment data, according to an exemplary embodiment of the present invention. Since the memory of the peripheral is recognized as supporting a MSC, the predetermined memory of the peripheral in which to store the establishment data is designated as an area of an external storage medium.

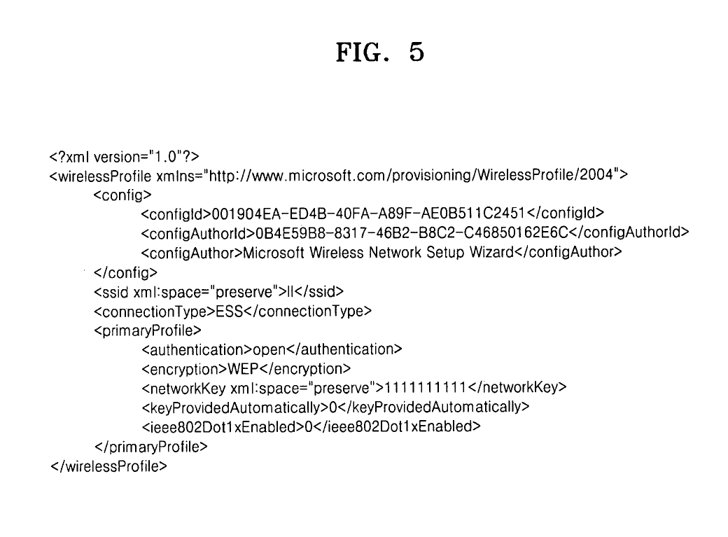

In operation 54, the establishment data is stored in the predetermined memory of the designated peripheral. The establishment data is converted into extensible markup language (XML) data and transmitted to the peripheral. FIG. 5 illustrates establishment data according to an exemplary embodiment of the present invention. The establishment data transmitted to the peripheral is stored in the predetermined memory of the designated peripheral.

In operation 56, the stored establishment data is examined to determine if it is valid. That is, it is determined whether the stored establishment data has information that can be used to establish the network. To do this, the stored establishment data can be examined for example, by checking header information of the stored establishment data, to determine whether the stored establishment data is valid. If it is determined that the stored establishment data is invalid, the process returns to operation 50.

If it is determined that the stored establishment data is valid, a state where the peripheral is recognized as supporting a MSC is released in operation 58. That is, when the peripheral receives valid establishment data from the host, the peripheral no longer has to operate according to the MSC specification. Thus, the peripheral releases the network connection state in which the peripheral is recognized by the host as supporting a MSC. If the peripheral does not transmit a response signal to the host in response to a response request signal transmitted by the host in the state where the peripheral is recognized as supporting a MSC, the network connection state in which the peripheral is recognized by the host as supporting a MSC is released from the host.

Referring back to FIG. 2, network establishment of the peripheral is performed by analyzing the stored establishment data in operation 36. In order to share the information for the network establishment, which is input from the host, with the peripheral, the establishment data that has been converted into the XML data format is analyzed, and network establishment is performed using the analyzed establishment data.

In operation 38, a user is then notified of a network establishment result.

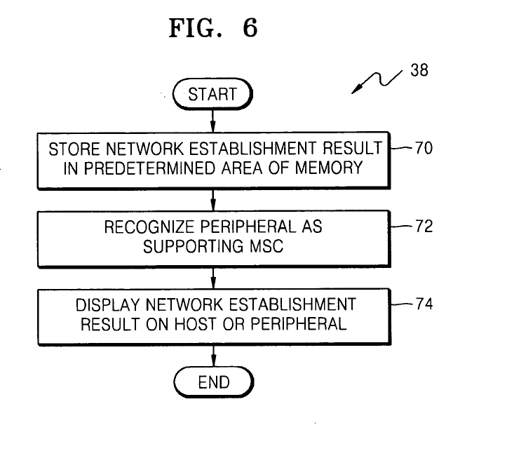

FIG. 6 is a flowchart illustrating operation 38 of FIG. 2 in greater detail, according to an exemplary embodiment of the present invention.

Referring to FIG. 6, a network establishment result is stored in the predetermined area of the memory of the peripheral in operation 70. That is, after completing the network establishment of the peripheral, a network establishment completion result is stored in the predetermined area of the memory of the peripheral.

In operation 72, the host recognizes the peripheral as supporting a MSC. That is, the host recognizes the peripheral as an external storage medium, i.e., an MSC-type storage medium, to access information indicating that the network establishment has been completed.

In operation 74, the network establishment result is displayed on the host and/or the peripheral. In detail, the network establishment result can be transmitted to the host and displayed through a display device. Also, the network establishment result stored in the predetermined area of the memory can be displayed through a display device of the peripheral.

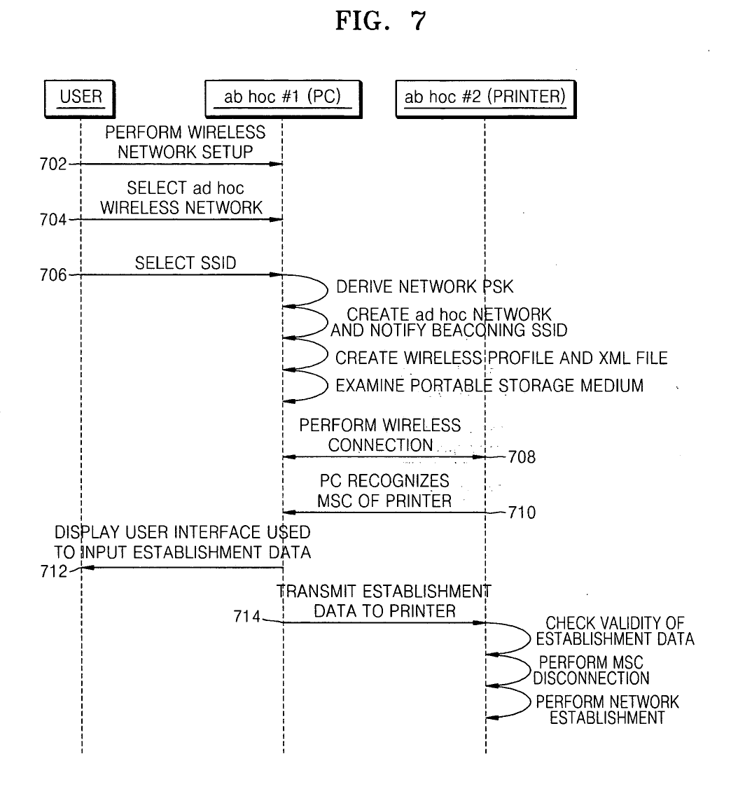

FIG. 7 is a signaling diagram for explaining a process of establishing a network between a personal computer (PC) and a printer according to an exemplary embodiment of the present invention. As illustrated in FIG. 7, when a user requests a wireless network setup (702) and selects a wireless network (704), an initial operation for establishing a network (706), such as selecting a service set identifier (SSID), creating a wireless profile XML file, and so forth, is performed. If the PC and the printer are wirelessly connected (708), the PC recognizes the printer as having a printer class and as supporting a MSC (710). When establishment data is input through a user interface of the PC (712), the input establishment data is transmitted to the printer (714) and stored in a predetermined area of a predetermined memory. The printer then determines whether the stored establishment data is valid. If it is determined that the stored establishment data is valid, the printer then performs network establishment of the peripheral.

The exemplary embodiments of the present invention can also be written as codes/instructions/programs and can be implemented in general-use digital computers that execute the codes/instructions/programs using a computer readable recording medium. Examples of the computer readable recording medium include magnetic storage media (e.g., ROM, floppy disks, hard disks and so forth), optical recording media (e.g., CD-ROMs, or DVDs), and storage media such as carrier waves (e.g., transmission through the Internet). The computer readable recording medium can also be distributed over network coupled computer systems so that the computer readable code is stored and executed in a distributed fashion. Also, functional programs, codes, and code segments for accomplishing embodiments of the present invention can be easily construed by programmers skilled in the art to which the present invention pertains.

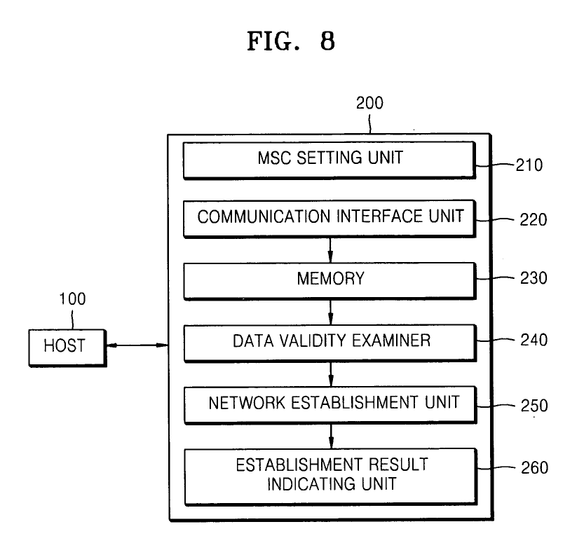

FIG. 8 is a block diagram of a network establishment system of a peripheral according to an exemplary embodiment of the present invention. Referring to FIG. 8, the system comprises a host 100 and a peripheral 200. Here, the peripheral 200 is an image forming device such as a printer, a scanner, a photocopier, or an MFP.

The peripheral 200 comprises an MSC setting unit 210, a communication interface unit 220, a memory 230, a data validity examiner 240, a network establishment unit 250 and an establishment result indicating unit 260. The peripheral 200 sets a predetermined area of the memory 230 as an area for a MSC, so that the peripheral 200 is recognized as supporting a MSC. To do this, the peripheral 200 includes the MSC setting unit 210. The MSC setting unit 210 sets the predetermined area of the memory 230 among data storage areas of the peripheral 200 as storage space, so that the predetermined area of the memory 230 can be used as an external storage medium.

The peripheral 200 includes the communication interface unit 220 to interface with the host 100. When the peripheral 200 is connected to the host 100, the communication interface unit 220 can interface with the host 100 in a wired or wireless manner. When the peripheral 200 is connected to the host 100 in a wired manner, a USB device or the like can be used, and when the peripheral 200 is connected to the host 100 in a wireless manner, a WUSB, Bluetooth device or the like can be used.

When the host 100 is connected to the peripheral 200, the host 100 recognizes the peripheral 200 as having a peripheral class and supporting a MSC and transmits establishment data input through a user interface (not shown) to the peripheral 200. The establishment data includes data for establishing a network between the host 100 and the peripheral 200 and includes device setup information, security information, file sharing information, and so forth.

The host 100 receives the establishment data through an application, and the memory 230 of the peripheral 200 in which the input establishment data is stored is designated. The host 100 converts the establishment data into XML data and transmits the establishment data that has been converted into XML format to the peripheral 200.

The peripheral 200 stores the establishment data transmitted from the host 100 and performs network establishment using the stored establishment data. To do this, the peripheral 200 includes the memory 230, the data validity examiner 240, the network establishment unit 250, and the establishment result indicating unit 260.

The memory 230 stores the establishment data in a predetermined area. The memory 230 can be a volatile memory (e.g., RAM) and/or a nonvolatile memory (e.g., a flash memory), which is installed in the peripheral 200.

The data validity examiner 240 examines whether the establishment data stored in the memory 230 is valid and outputs the examination result to the network establishment unit 250. That is, the data validity examiner 240 determines whether the stored establishment data has information that can be used for network establishment. To do this, the data validity examiner 240 checks for example, header information of the stored establishment data.

If the stored establishment data is valid, the network establishment unit 250 performs network establishment of the peripheral 200 by analyzing the stored establishment data. In order to share the information for the network establishment, which is input from the host 100, with the peripheral 200, the network establishment unit 250 analyzes the XML data format establishment data and performs the network establishment using the analyzed establishment data.

The establishment result indicating unit 260 informs the user of the network establishment result after network establishment is performed. The establishment result indicating unit 260 stores the network establishment result in a predetermined area of a predetermined memory of the peripheral and displays the stored network establishment result through a display device (not shown) of the peripheral 200. The establishment result indicating unit 260 transmits the network establishment result to the host 100 via the communication interface unit 220. The host 100 then receives the network establishment result from the peripheral 200 and displays the network establishment result on a display device (not shown) thereof.

As described above, since a network establishment method and system of a peripheral according to embodiments of the present invention can reduce complicated operations for network establishment of the peripheral using a portable storage medium and perform network establishment without a USB host or an interface with the portable storage medium, which must be included by using the portable storage medium, a system can be simplified and network establishment can be performed at lower cost.

While the present invention has been particularly shown and described with reference to exemplary embodiments thereof, it will be understood by those of ordinary skill in the art that various changes in form and detail may be made therein without departing from the spirit and scope of the present invention as defined by the following claims and equivalents.

What is claimed is:

1. A method for network establishment of a peripheral, the method comprising:
setting a predetermined area of a memory of a peripheral as an area for a mass storage class (MSC);
storing establishment data for networking a host and the peripheral in the predetermined area of the peripheral supporting the MSC; and
performing network establishment of the peripheral using the stored establishment data.

2. The method of claim 1, further comprising recognizing the peripheral by the host as supporting the MSC.

3. The method of claim 1, wherein the memory comprises a volatile memory or a nonvolatile memory installed in the peripheral.

4. The method of claim 1, wherein performing network establishment of the peripheral comprises:
connecting the peripheral to the host;
recognizing the peripheral by the host as having a peripheral class and supporting the MSC;
storing the establishment data used to establish a network between the host and the peripheral in the predetermined area of the peripheral; and
performing network establishment of the peripheral by analyzing the stored establishment data.

5. The method of claim 4, wherein the peripheral is connected to the host in a wired or wireless manner.

6. The method of claim 4, wherein storing establishment data in the predetermined area of the peripheral comprises:
receiving the establishment data from the host;
designating the memory in which to store the input establishment data;
storing the input establishment data in the predetermined area of the designated memory of the peripheral;
examining whether the stored establishment data is valid; and
if the stored establishment data is valid, releasing a state where the peripheral is recognized as supporting the MSC.

7. The method of claim 1, further comprising informing a user of the network establishment result after performing the network establishment of the peripheral.

8. The method of claim 7, wherein informing of the network establishment result comprises:
storing the network establishment result in the predetermined area of the memory;
recognizing the peripheral by the host as supporting the MSC; and
displaying the network establishment result by the host.

9. The method of claim 7, wherein informing of the network establishment result comprises displaying the network establishment result by the peripheral.

10. A computer readable recording medium storing a computer readable program for providing network establishment of a peripheral, comprising:
a first set of instructions for setting a predetermined area of a memory of a peripheral as an area for a mass storage class (MSC);
a second set of instructions for storing establishment data for networking a host and the peripheral in the predetermined area of the peripheral supporting the MSC; and
a third set of instructions for performing network establishment of the peripheral using the stored establishment data.

11. A network establishment system of a peripheral, the system comprising:
a peripheral comprising a memory, wherein the peripheral is configured to set a predetermined area of the memory as an area for a mass storage class (MSC), store establishment data for the network in the predetermined area of the peripheral, and perform network establishment using the stored establishment data; and
a host for recognizing the peripheral as having a peripheral class and supporting the MSC when the peripheral is connected to the host and transmitting the establishment data to the peripheral.

12. The system of claim 11, wherein the peripheral further comprises:
a communication interface unit for accessing the host;
an MSC setting unit for setting a predetermined area of the memory of the peripheral for the MSC;
the memory for storing the establishment data in the predetermined area according to the setting performed by the MSC setting unit;
a data validity examiner for examining whether the stored establishment data is valid; and
a network establishment unit for performing network establishment of the peripheral by analyzing the stored establishment data if the stored establishment data is valid.

13. The system of claim 12, wherein the communication interface unit is configured to access the host in a wired or wireless manner.

14. The system of claim 12, wherein the memory comprises a volatile memory or a nonvolatile memory installed in the peripheral.

15. The system of claim 11, wherein the peripheral further comprises an establishment result indicating unit for informing a user of a network establishment result after performing the network establishment.

16. The system of claim 15, wherein the establishment result indicating unit is configured to store the network establishment result in the predetermined area of the memory and display the network establishment result on a display device of the peripheral.

17. The system of claim 11, wherein the host is configured to receive the establishment data, designate the predetermined area of the peripheral in which to store the input establishment data, and transmit the establishment data to the predetermined area of the peripheral.

18. The system of claim 11, wherein the host is configured to receive the network establishment result from the peripheral and display the result on a display device of the host.

19. The system of claim 11, wherein the peripheral comprises an image forming device.

20. A peripheral for network establishment, the peripheral comprising:
a means to connect with a host and receive establishment data transmitted by the host;
a means to set a predetermined area of a peripheral memory as an area for a mass storage class (MSC) and store the establishment data for a network in the predetermined area of the peripheral memory; and
a means to perform network establishment using the stored establishment data.
